(19) United States
(12) Patent Application Publication
(10) Pub. No.: US 2008/0228971 A1
(43) Pub. Date: Sep. 18, 2008

(54) Device modeling in a multi-core environment

(76) Inventors: Michael A. Rothman, Puyailop, WA (US); Vincent J. Zimmer, Federal Way, WA (US)

Correspondence Address: INTEL CORPORATION;c/o INTELLEVATE, LLC, P.O. BOX 52050, MINNEAPOLIS, MN, 55402, US

(21) Appl. No.: 11/717,567

(22) Filed: Mar. 13, 2007

(51) Int. Cl. G06F 13/00; G06F 13/10; G06F 9/445

(52) U.S. Cl. 710/104; 703/21; 718/1

(57) ABSTRACT

A method and apparatus for modeling devices in a multi-core environment is herein described. A hardware offload engine or add-in device is modeled by offload engine code or device model code stored in memory. An event agent in a hypervisor traps accesses to the offload engine or add-in device and routes them to at least one core of a multi-core processor to be serviced. The core of the multi-core processor executes the offload engine code or device model code to emulate the physical hardware offload engine or add-in device to service the access. Therefore, virtual devices may be provided by providing virtual device code, allowing upgrade of a computer system without adding physical hardware.

### FIELD

This invention relates to the field of computer systems and, in particular, to modeling devices in computer systems.

### BACKGROUND

Advances in semi-conductor processing and logic design have permitted an increase in the amount of logic that may be present on integrated circuit devices. As a result, computer system configurations have evolved from a single or multiple integrated circuits in a system to multiple cores and multiple logical processors present on individual integrated circuits. A processor or integrated circuit typically comprises a single processor die, where the processor die may include any number of processing resources, such as cores, threads, and/or logical processors.

In fact, single integrated circuits including 8, 16, 32, 64, and a higher number of cores are currently being contemplated. However, available software and operating systems potentially have difficulty efficiently utilizing a large number of cores in a single system. As a result, some of the cores of a processor may be underutilized. In addition, to upgrade peripheral components of a computer system, a user often is required to purchase additional hardware, such as an upgraded graphics accelerator, a network processor, an audio processor, or other add-in device.

### BRIEF DESCRIPTION OF THE DRAWINGS

The present invention is illustrated by way of example and not intended to be limited by the figures of the accompanying drawings.

FIG. 1 illustrates an embodiment of a system including an emulated device model.

FIG. 2 illustrates an embodiment of multi-core computer system including a plurality of virtual devices.

FIG. 3 illustrates an embodiment of a flow diagram for a method of emulating an offload engine.

FIG. 4 illustrates an embodiment of a flow diagram for a method of providing a virtual offload engine.

### DETAILED DESCRIPTION

In the following description, numerous specific details are set forth such as examples of specific add-in devices, specific hypervisor implementation, option ROM information etc. in order to provide a thorough understanding of the present invention. It will be apparent, however, to one skilled in the art that these specific details need not be employed to practice the present invention. In other instances, well known components or methods, such as virtual machine monitor operation/implementation, virtual machines, specific code, and specific operational details of microprocessors, have not been described in detail in order to avoid unnecessarily obscuring the present invention.

The method and apparatus described herein are for modeling devices in a multi-core environment. Specifically, modeling devices in a multi-core environment is primarily discussed in reference to a multi-core computer system. However, the methods and apparatus described herein are not so limited, as they may be implemented on or in association with any integrated circuit device or system, such as cell phones, personal digital assistants, embedded controllers, mobile platforms, desktop platforms, and server platforms, as well as in conjunction with any type of processing resource, such as a thread or logical processor.

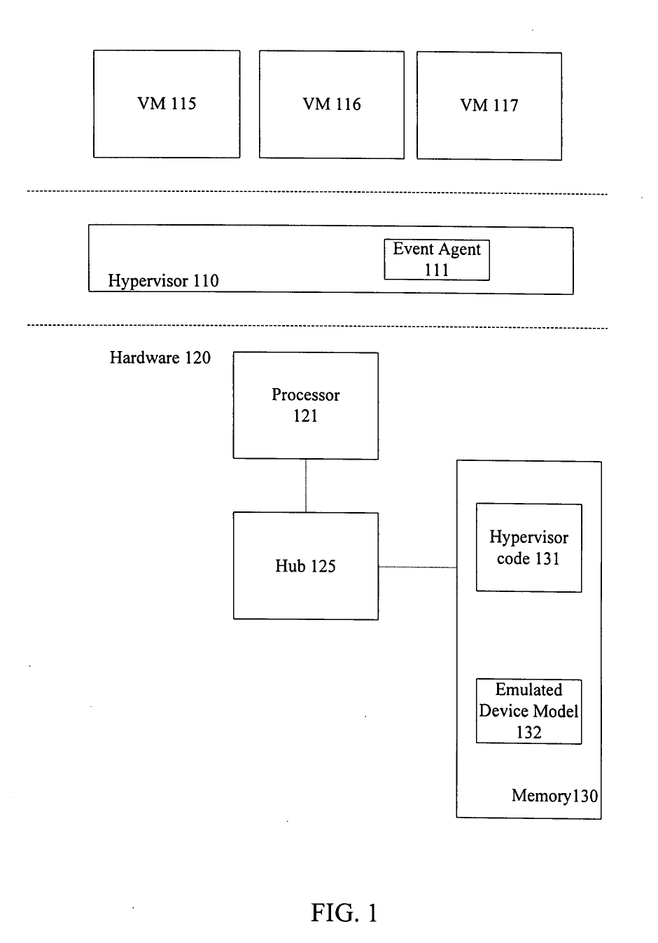

Referring to FIG. 1, an embodiment of a system including emulated device model code is illustrated. Hardware 120 includes processor 121, hub 125, and memory 130. Hub 125 includes any device for communication between processor 121 and memory 130, such as a memory controller hub or chipset. Note that hub 125 may be integrated in processor 121 or memory 130. Processor 121 includes a plurality of processing resources. A processing resource refers to a thread, a process, a context, a virtual machine, a logical processor, a hardware thread, a core, and/or a processor. A physical processor typically refers to an integrated circuit, which potentially includes any number of other processing resources, such as cores or hardware threads.

A core often refers to any logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to at least some execution resources. As can be seen, when certain processing resources are shared and others are dedicated to an architectural state, the line between the nomenclature of a hardware thread and core overlaps. Yet often, a core and a hardware thread are viewed from a software perspective as individual logical processors, where the operating system is able to individually schedule operations on each logical processor.

In one embodiment, processor 121 is a multi-resource microprocessor. As an example, processor 121 includes a plurality of cores. Here, cores are potentially designated in hardware, software, and/or firmware for different tasks. For example, a first number of cores of the plurality of cores are designated for essential processing tasks, such as execution associated with operating system code or applications associated with an operating system. To illustrate, assume processor 121 includes 32 cores. In one case, 24 of the 32 cores are visible to an operating system, while 8 of the 32 cores are designated as spare cores, which are discussed in more detail below.

Continuing the example from above, a second number of the plurality of cores are designated as spare cores. In one embodiment, a spare core is a core not designated for essential processing tasks, such as execution of operating system code or application code associated with an operating system. Here, a spare core is potentially not visible to operating system code executing on processor 121. In one embodiment, a spare core is designated as a core to be associated with an offload engine model and/or emulated device model. Additionally, a spare core may be a core designated to replace other defective cores. As an example, associating a spare core with an offload engine model or emulated device model includes performing emulation tasks with the spare core.

The example above discusses use of a single spare core to support emulation of a device. However, utilizing cores to emulate devices is not so limited. For example, any core, such as an essential core, may be tasked with executing operations to emulate an add-in device. Moreover, multiple cores, which may include essential cores, spare cores, or a combination thereof, may be tasked to emulate a single hardware device.

Hardware 120 includes processor 121 coupled to memory 130 through controller hub 125. However, hardware 120 may include any hardware in an integrated circuit system. Examples of memory 130 include dynamic random access memory (DRAM), static RAM (SRAM), non-volatile memory (NV memory), and long-term storage. Memory 130 is to store hypervisor code 131 and emulated device model code 132 to be executed by processor 121. Note that a hypervisor may be implemented in hardware, firmware, and software stored through out a system.

Here, hypervisor code 131, when executed, is to provide an interface, i.e. hypervisor monitor 110, between software, such as virtual machines (VMs) 115-117, and hardware, such as hardware 120. Often hypervisor code 131 abstracts hardware 120 to allow multiple guest applications to run independently on hardware 120. Virtual machines 115-117 may be an operating system, an application, guest software, or other software to be executed on hardware 120. Previously, to upgrade hardware 120 an add-in device or offload engine would be physically added to hardware 120 and a driver would be loaded in memory 130 for the add-in device. Upon an access to the device, i.e. the driver space for the device, the access would be routed to the physical add-in device to service the access.

Here, in one embodiment, emulated device model code 132, when executed, is to emulate a physical add-in device. As a result, event agent 111 is to detect and route accesses to a processing resource of processor 121, which is to execute emulated device model code 132. Therefore, instead of adding a physical device, emulated device code is loaded in memory 130 and a processing resource of processor 121 is tasked to service accesses to the device. As a result, a core of processor 121 performs the add-in device functionality through execution of emulated device model code 132 with a core of processor 121 without having to physical insert the add-in device.

From an operating system or other guest application perspective, adding, accessing, and/or removing an emulated or soft device, in one embodiment, is the same as adding, accessing, and/or removing a physical device. In both implementations, processing engines, i.e. a processing resource of processor 121 and a processing resource of a physical add-in device, service accesses from software to the device. In fact, addition or removal of a soft/emulated device may be emulated through triggering a traditional device add/remove event, such as a hot swap event, when the soft device code is loaded in the system, to make the device visible and accessible by guest applications, such as an operating system.

Emulated device model code 132 includes information about a corresponding emulated device model as well as operational code, when executed, to emulate a physical device. An emulated device may also be referred to as an emulated offload engine, a virtual offload engine (VOE), a soft device, a virtual device, or other reference to execution of code to model/emulate a physical device in a computer system. Examples of physical devices and offload engines that may be modeled/emulated include a video device, a graphics device, an audio device, a networking device, an interconnect device, a network interface controller (NIC), a network processor, a graphics accelerator, a physics engine, a RAID device, a video offload engine, a direct memory access (DMA) engine, a transaction offload engine, and an audio processor. Specific illustrative examples include a graphics accelerator, such as a PCI-Express graphics card and/or physics accelerator engine, an audio processor card, a wireless or wired networking card, and an interconnect hub/device.

In one embodiment, emulated device code 132 includes information about an emulated device, i.e. a virtual offload engine. Typically, an add-in device includes an option read only memory (ROM) to provide information about the physical device. Similarly, emulated device code 132 may include information about the emulated device, such as identifiers, features, and specifications of the emulated device. Examples of option information/elements include a device identifier (ID), a vendor ID, status information, command information, a class code, a revision ID, header information, latency information, a base address element, a base address of an emulated base address register (BAR), a subsystem identifier, an extension base address, and interrupt information.

Additionally, emulated device code 132 also includes operational code. As a first example, operational code includes code to emulate an offload engine and/or add-in device. Here, the operational code includes case calls to perform operations in response to specified cases. Operational code may also include other common code associated with a device, such as device driver code, as well as any other code to emulate operation of a physical device. A physical add-in device often includes a processing resource, such as an offload engine or device processor. Typically, a processing resource in a physical device, such as an add-in card, is referred to as an offload engine as it performs operations relating to the physical device, which “offloads” those operations from having to be performed on a micro-processor or other processor in the system. Therefore, a processing resource of processor 121 is associated with emulated device code 132. In on embodiment, the processing resource of processor 121 is designated, and may even be exclusively dedicated, to executing emulated device code 132 and servicing accesses to a memory space associated therewith.

In one embodiment, hypervisor 110 includes event agent 111. A Virtual Machine Monitor (VMM) is one example of hypervisor 110. Here, VMM code 131 includes event management code for event agent 111. Event management code, when executed, is to associate accesses to an offload engine memory space with a core of processor 121. As a result, when an access to an offload engine is detected, event agent 111 traps the access and routes the access to a core of processor 121. The offload engine memory space includes a range of memory locations/addresses that are associated with the virtual offload engine. For example, the range of addresses may include a range specified by hypervisor 110, by VMs 115-117, and/or in option information in emulated device code 132, such as locations of emulated base address registers and emulated configuration elements.

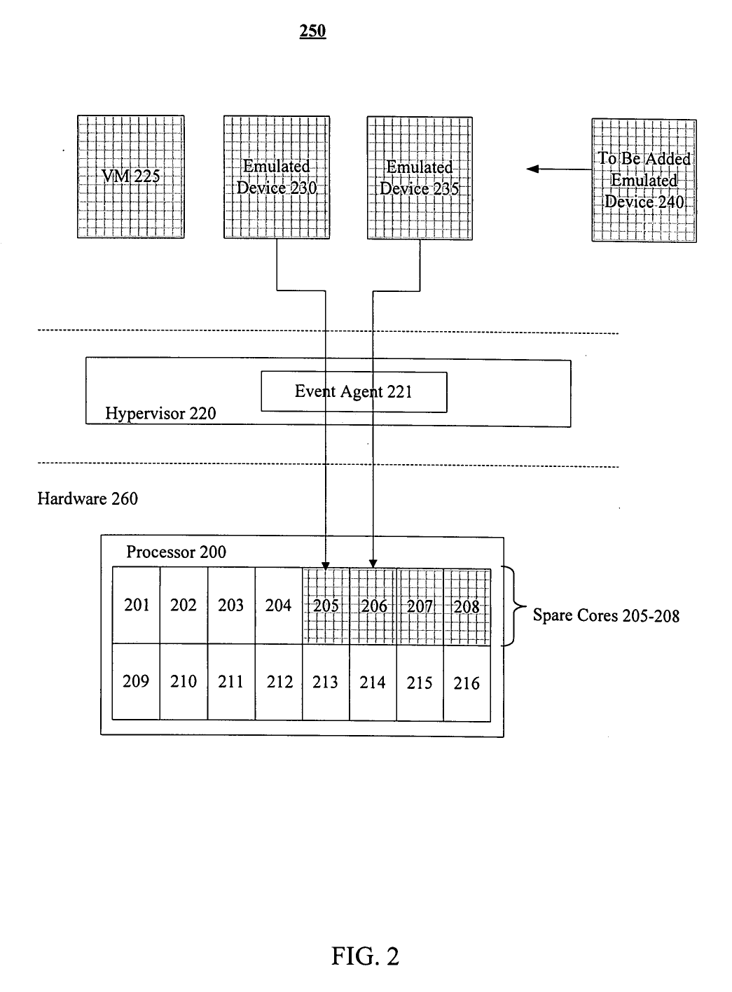

Turning to FIG. 2, an embodiment of a system capable of emulating physical devices is illustrated. Here, device 230 and 235 are already being actively emulated in system 250 and device 240 is to be added to system 250. Previously, device 240 is a physical device, such as a physical physics accelerator card, including components such as a physics processor and memory, which would be added to hardware 260. However, in the embodiment illustrated, device 240 is a virtual/soft/emulated device to be added to system 250, instead of a physical device. Consequently, emulated device code is loaded or made accessible in memory of system 250. In on embodiment, an add-in event is performed to inform VM 225, which may be an operating system, of the addition of device 240. As an example, device 240 is added in a device manager of an operating system and associated with a driver, code, or memory space, such as a virtual device space. In one embodiment, a memory space associated with device 240 includes any combination of a memory space including code to emulate device 240, locations utilized to emulate storage elements of device 240, and any other memory location commonly associated with a physical device.

Event agent 221, which currently associates emulated devices 230 and 235 with cores 205 and 206, respectively, now associates device 240 with core 207 and/or 208 of processor 200. In one embodiment, cores 205-208 are spare cores of processor 200 to be associated with an emulated device code. In another embodiment, cores 205-208 are to be provided as replacement cores for essential processing cores 201-204 and 209-216. Event agent 221 in hypervisor 220 traps accesses from VM 225 to virtual device 240, i.e. the virtual device space associated with virtual device 240, and routes them to processor 200, specifically, core(s) 207 and/or 208, to be serviced.

From VM 225's perspective, an access is initiated to a memory space associated with device 240, as if device 240 is a physical device. However, instead of driver code or hypervisor 220 routing to a processing resource of a physical add-in card, the access is serviced by core(s) 207 and/or 208 executing emulated device code associated with device 240. In one embodiment, at least one core, such as core 207, is exclusively designated to service accesses associated with device 240 through execution of code associated with emulated device 240. As an example, routing an access to core 207 includes, in response to event agent 221 determining the destination of the access, i.e. emulated device 240, an operation or a plurality of operations is scheduled on core 207 to service the access.

As can be seen, a plurality of devices may be modeled in a system, such as system 250. Furthermore, groupings from a single core to multiple cores may be dedicated to a particular emulated device. For example, if more graphics processing power is required in a system, more cores may be assigned or designated to service accesses to an emulated graphics or physics accelerator. Note that the emulated device code, hypervisor code, or other code potentially determines how many cores to assign to an emulated device. In addition, the determination of a number of cores to associate with an emulated device may be dynamically performed, which allows a processor to dynamically adjust the designation and usage of processing resources to ensure efficient utilize all of its processing resources.

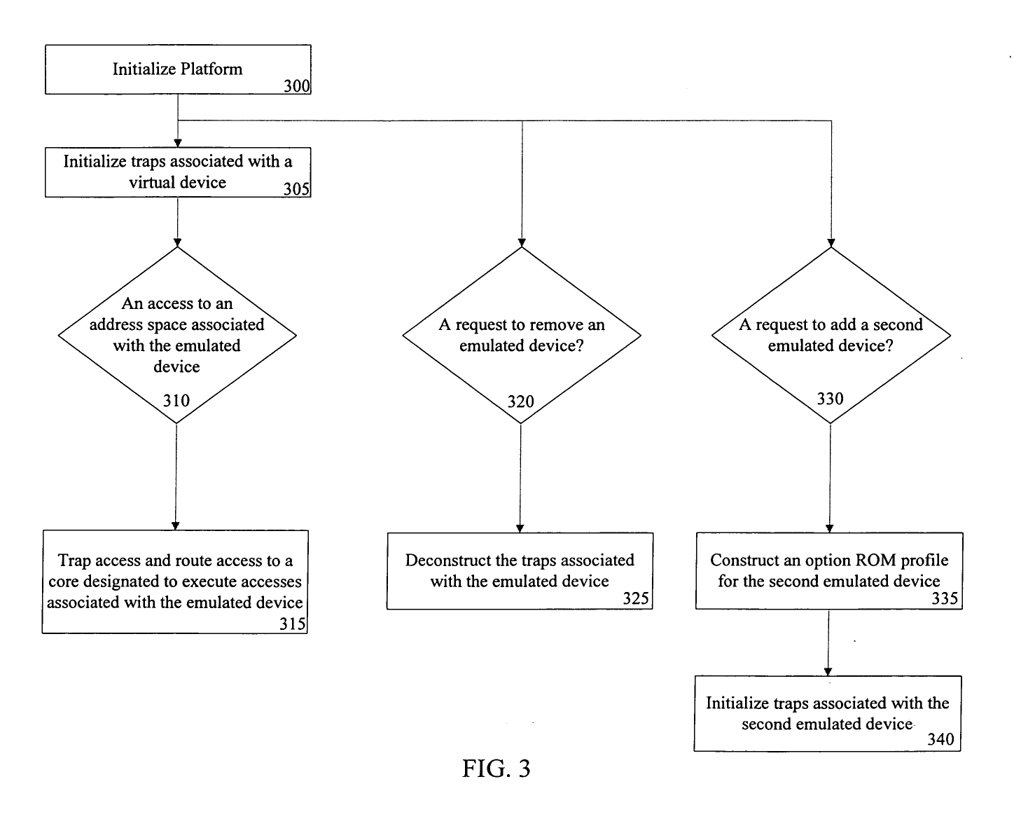

Referring next to FIG. 3, an embodiment of a flow diagram for a method of emulating an offload engine is illustrated. In flow 300, a platform is initialized. Normal boot and Power On Self Test (POST) operations, as well as any other platform initializations, may take place in flow 305. If any virtual offload engines/devices exist in the system upon boot, then in flow 300, traps associated with the virtual offload engines/devices are initialized. Here, it is assume the option information has already been loaded in the system for the virtual device. Initialization of traps, in one embodiment, includes initializing an event agent in a hypervisor to associate an address space with an emulated device. Note an address space may include any space or locations associated with an emulated device, such as a configuration space and/or emulated base address register space.

In flow 310 it is determined if an access is an access to the address space associated with the emulated device. Continuing the illustrative example above, an event agent in a hypervisor detects the access. In one embodiment, the event agent retrieves the source of the access and establishes a target, such as a core designated to service accesses associated with the emulated device, for routing the request. Next, in flow 315, the accesses is routed to the core designated to service accesses associated with the emulated device. Here, the core executes emulated device code to service the access in a similar manner that a physical device, which is being emulated would service the access. In other words, the designated core executes emulated device code, i.e. case calls or other operations, to service the access.

Alternatively, in flow 320, after initialization, if a request to remove the emulated device is received, then in flow 325 the traps that were initialized in flow 305 are deconstructed. In addition, a removal event may be performed to remove the device from visibility of software, such as an operating system. For example, the removal of a virtual device may be registered by a device manager in an operating system.

In contrast, in flow 330 if a request to add a second emulated device is detected, then in flow 335 an option Read Only Memory (ROM) profile is constructed for the second device. The information from a physical device option ROM is emulated to provide information about features of the second emulated device as well as addresses of configuration space and base address elements. Other information commonly associated with a physical add-in device may be included in the constructed option ROM emulation. Additionally, in flow 340, traps associated with the second emulated device are initialized.

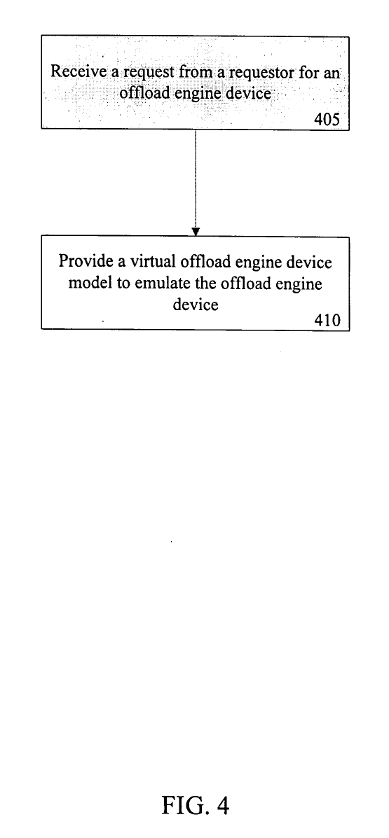

Turning next to FIG. 4, an embodiment of a flow diagram for a method of providing a virtual offload engine (VOE) device is illustrated. In one embodiment, a potential advantage of providing a soft or virtual offload engine/device includes the ability to upgrade or alter a configuration of a computer system without having to add physical hardware. Therefore, a user is potentially able to alter their system without ever having to open their physical case to insert a physical device. From a different perspective, sellers are able to provide additional equipment functionality to users without having to provide physical hardware.

To illustrate, in flow 405, a request from a requestor for an offload engine device is received. In one embodiment, the requestor is the computer system transmitting the request to a supplier or sellers server to purchase, download, or otherwise attempt to acquire the offload engine. In another embodiment, the requester is a user purchasing, copying, or otherwise attempting to acquire an offload engine device.

In flow 410, a virtual offload engine device model to emulate the offload engine device is provided in response to the request. In one embodiment, providing a VOE device model includes allowing a download of a VOE device model or VOE code. In another embodiment, the VOE code may already loaded in a computer system, and providing a VOE includes allowing access to the VOE code. For example, a VOE is already installed on a system, when shipped, and later, in response to the request, providing a key for the user to allow the system to execute the VOE code. Essentially, in this embodiment, the VOE code always resides in the system, but the upgrade, i.e. the ability to execute the VOE code, is not provided until requested, i.e. through a purchase. Providing also includes any other method or medium for providing a VOE. As an example, receiving payment for a VOE and then providing may include allowing download of the VOE, sending the VOE code, or shipping a tangible medium a including the VOE to be installed by or on the requestor.

As another illustrative example, a computer manufacturer or distributor sells a computer system with a multi-core microprocessor to a user. Later, the user determines they need to upgrade the graphics performance of the computer system by adding a physics accelerator. The user then accesses the manufacturer's, distributor's, or a third-parties website to purchase a physics accelerator to work in conjunction with the graphics accelerator in the computer system. After purchase, either through download or receiving shipment, a virtual physics accelerator, i.e. virtual offload engine (VOE), to emulate the device is loaded/installed on the computer system. As described above, at least one core and potentially a plurality of cores is associated with the virtual physics accelerator to execute virtual physics accelerator code and service accesses to the virtual physics accelerator. Therefore, a user has been able to add-in a physics accelerator by installing/loading code on the computer system supported by processor cores instead of having to physically install a physics accelerator card.

The embodiments of methods, software, firmware or code set forth above may be implemented via instructions or code stored on a machine-accessible or machine readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A method comprising:
receiving a request from a requestor for an offload engine device;
providing a virtual offload engine (VOE) device model to emulate the offload engine device in response the request from the requestor for the offload engine device, wherein the VOE device model is to be associated with at least one core of a multi-core processor associated with the requester.

2. The method of claim 1, wherein the requestor includes a remote computer system.

3. The method of claim 2, wherein receiving a request from a requestor for an offload engine device includes receiving payment to add the offload engine device to the remote computer system, and wherein providing a VOE device model to emulate the offload engine device includes: allowing the VOE device model to be added to the remote computer system in response to receiving payment to add the offload engine device to the remote computer system

4. The method of claim 2, wherein the offload engine device is selected from a group consisting of a network interface controller (NIC), a network processor, a graphics accelerator, a physics engine, a RAID device, a video offload engine, a direct memory access (DMA) engine, a transaction offload engine, and an audio processor, and wherein the VOE device model includes code, when executed, to emulate the offload engine device.

5. An article of manufacture including program code which, when executed by a machine, causes the machine to perform the operations of:
trapping an access to an address space associated with a soft device model; and
routing the access to a core of a multi-core microprocessor to service the access, wherein the core of the multi-core microprocessor is designated to service accesses to the address space associated with the soft device model.

6. The article of manufacture of claim 5, wherein the program code is included within hypervisor code also included in the article of manufacture.

7. The article of manufacture of claim 5, wherein the soft device model includes device model code, when executed, to model a hardware add-in device, and wherein the address space associated with the soft device model includes a configuration space and a base address space associated with the soft device model.

8. The article of manufacture of claim 7, wherein the hardware add-in device is selected from a group consisting of a graphics device, an audio device, a networking device, and an interconnect device.

9. The article of manufacture of claim 5, wherein the core of the multi-core microprocessor is a spare core of the multi-core microprocessor.

10. The article of manufacture of claim 5, wherein routing the access to the core to service the access includes scheduling the access to be executed with the core.

11. A system comprising:
a microprocessor including a plurality of cores; and
a memory device to store:
emulated offload engine code, when executed on the microprocessor, to emulate an offload engine, and
event management code, when executed with the microprocessor, to associate accesses to an offload engine memory space, which is associated with the emulated offload engine code, with at least one core of the plurality of cores.

12. The system of claim 11, wherein the emulated device code includes option information and operational code.

13. The system of claim 12, wherein the option information includes a plurality of option elements wherein each of the plurality of option elements are selected from a group consisting of a device identifier, a vendor identifier, status information, command information, a class code, a revision identifier, header information, latency information, a base address element, a subsystem identifier, an extension base address, and interrupt information, and wherein the operational code includes case calls to emulate operations of the offload engine.

14. The system of claim 11, wherein the memory device is also to store hypervisor code, wherein the event management code is included in the hypervisor code.

15. The system of claim 11, wherein offload engine is selected from a group consisting of a video engine, an audio engine, and a network engine.

16. The system of claim 11, wherein the at least one core of the plurality of cores is, by default, designated as a spare core.

17. The system of claim 11, wherein the event management code, when executed with the microprocessor, to associate accesses to an offload engine memory space with the at least one core comprises: trapping the accesses to the offload engine memory space and routing the accesses to the at least one core.
